(19) United States
(12) Patent Application Publication
(10) Pub. No.: US 2002/0180383 A1
(43) Pub. Date: Dec. 5, 2002

(54) Electronic HID ballast and a PPM method of preventing acoustic arc resonance

(76) Inventors: Mingfu Gong, Cupertino, CA (US); Da Heng Yin, Beijing (CN); Kai Sheng Zhao, Beijing (CN); Zun Qiao Zhang, Beijing (CN); Yuan Zhen Wu, Beijing (CN)

Correspondence Address: MINGFU GONG, 10284 ALPINE DR. UNITA, CUPERTINO, CA, 95014, US

(21) Appl. No.: 10/122,061

(22) Filed: Apr. 12, 2002

Related U.S. Application Data
(60) Provisional application No. 60/284,012, filed on Apr. 16, 2001.

(51) Int. Cl. H05B 37/02

(52) U.S. Cl. 315/291

(57) ABSTRACT

The electronic HID ballast includes a Pulse-Phase-Modulation (PPM) pulse source, a switch driver, a power switching circuit, a coupling circuit, a DC starter, a switch current amplitude feedback circuit and a switch current pulse width feedback circuit. The PPM pulse source works at PPM mode with a fixed frequency to prevent acoustic arc resonance, and uses pulse deduction method to protect the ballast from overload during the starting period. The PPM pulse source, the switch driver, the switch current amplitude feedback circuit and the power switching circuit work together, functioning as a constant power switching source to energize lamp through the coupling circuit. The power switching circuit and the lamp are in DC series connection for the open load protection. The coupling circuit uses parallel LRC loop to improve power coupling efficiency between the lamp and the power switching circuit. The DC starter works at the low igniting frequency to offer open circuit protection for the starter itself.

PROVISIONAL APPLICATION PRIORITY DATE

| 60/284,012 | 04/16/2001 | Gong et al. |
|---|---|---|
| REFERENCES | | |
| 5,428,268 | 06/27/1995 | Melis; et al |
| 5,796,216 | 08/18/1998 | Beasley; |
| 5, 883, 475 | 03/16/1999 | Beasley; |
| 6,107,754 | 08/22/2000 | Kim; |
| 6,157,142 | 12/05/2000 | Moisin; |
| 6,124,681 | 09/26/2000 | Choi; |

### BACKGROUND OF THE INVENTION

High-Intensity-Discharge (HID) lamps are widely used for outdoor lighting because of its high efficiency and long lamp life, but following HID lamp characteristics affect current HID ballasts cost and reliability:

1. Low work voltage (50 v-100 v), and high ignition voltage (>1500 v).

2. Lamp stays at very low voltage drop (<⅓ normal lamp voltage) after the ignition until the lamp reached its fill power. Normally this period lasts several minutes. It requires HID ballasts that can withstand over load.

3. Highly dynamic characteristic loads, changing instantly from low impedance to open circuit or from open circuit to low impedance. It requires HID ballasts that must have a constant power output with robust open load and over load protection.

4. Acoustic arc resonance (AAR) that could happen at any frequency from several hundred Hz to several hundred KHz, and causes HID lamp arc instability or lamp damage. The AAR frequency may vary from lamp to lamp and may change as the lamp aging. AAR is not a problem for magnetic HID ballasts that work at 50 or 60 Hz power line frequency, but most of electronic ballasts work within the frequency range and have to deal with AAR.

Magnetic HID ballasts use large power transformer to handle overload during starting period, with the cost of low power factor, heavy weight, and low efficiency. Normally an expensive power capacitor is used in magnetic HID ballast to compensate power factor.

The high frequency electronic HID ballasts have advantages over magnetic HID ballasts on size, weight, efficiency and power factor. To replace magnetic HID ballasts, the high frequency electronic HID ballasts must effectively control AAR and have robust open load and over load protection with reasonable cost.

Most of current high frequency electronic HID ballasts use the Pulse-Frequency-Modulation (PFM) method to prevent AAR. The major problem with PFM is the acoustic noise and electromagnetic noise. The quick frequency jumps in PFM can effectively prevent AAR, but also increase noise level. The slower frequency jumps can reduce the noise level but may not completely prevent AAR. Some designs use fast AAR feedback circuit to trigger the frequency jump whenever AAR is detected. This approach can minimize acoustic noise, but may introduce extra cost. The PFM method also increases ballast design difficulty because the ballast circuit needs to be optimized for multiple work frequencies.

The ballast open load and over load protection needs to be reliable and low cost. Ideally the starter should work at a low ignition frequency, a few pulses per second, to extend the lamp and the starter life, and to offer open load protection for the starter itself.

### BRIEF SUMMERY OF THE INVENTION

The main object of the present invention is to provide a high frequency electronic HID ballast design with reliable and low cost solutions for the above-mentioned problems.

It is an object of the present invention to use the PPM switching power source to implement the low cost and high efficiency electronic ballast for HID lamp. The switching power source works at a fixed frequency with PPM to prevent AAR. The PPM can be two or more phases with maximum phase jump distance <=ten pulse periods.

A further object of the present invention is to use the pulse deduction method to prevent the ballast from overload, and to prevent the lamp from over current during the starting period. Whenever an overload condition is detected, the pulse source suspends next pulse output to reduce ballast's output power. At the worst case, this method can cut the output power by half

Another object of the present invention is to use a DC starter in the ballast circuit to achieve adjustable ignition frequency. The ignition frequency is adjusted to a few pulses per second. This low ignition frequency also makes the DC starter open load protected.

Another object of the present invention is to offer open load protection in the ballast circuit by making the lamp and the power switch in DC series connection. Whenever the lamp is disconnected, only a weak DC starter current will go through switching power source.

The final object of the present invention is to use a parallel LRC loop as the coupling circuit to improve power coupling efficiency between the lamp and the switching power source.

### BRIF DESCRIPTION OF THE SEVERAL VIEWS OF THE DRAWING

FIG. 1 is the circuit of electronic ballast for HID lamp according to the present invention;

FIG. 2 is the other circuit of the electronic ballast for HID lamp according to the present invention, modified from FIG. 1 with extra circuits to remove lamp DC bias at normal working mode; and

FIG. 3 is an implementation of the preset invention based on circuit shown in FIG. 1, with programmed MPU as PPM pulse source 1, LMC555 as the power switch driver 2, resistor R42 and transistor T40 as current amplitude feedback circuit 3, and MOSFET as switch 5.

### DETAILED DESCRIPTION OF THE INVENTION

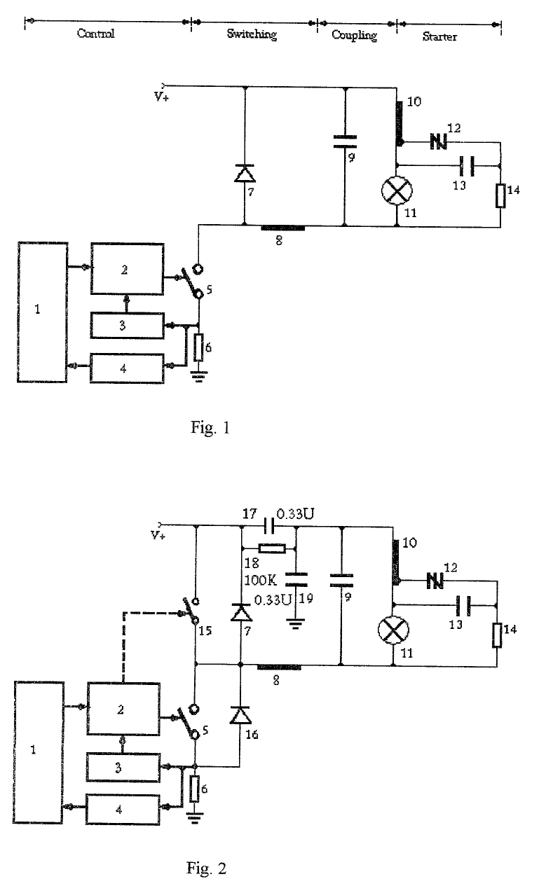

FIG. 1 shows the ballast circuit for energizing HID lamp 11. The ballast includes a PPM pulse source 1, switch driver 2, switch current amplitude feedback circuit 3, switch current width feedback circuit 4, the power switching circuit, the coupling circuit and the DC starter circuit.

The power switching circuit includes switch 5, current sampling resistor 6, diode 7 and inductor 8. The power switching circuit is used to energize lamp 11 through the coupling circuit. Switch 5 can be a MOSFET, an IGBT, or a bipolar transistor.

The coupling circuit includes capacitor 9, inductor 10 and lamp 11, and is used to improve power coupling between the power switching circuit and lamp 11. The parallel LRC connection of capacitor 9 and inductor 10 boosts the equivalent load resistance of lamp 11 in the power switching circuit, especially during the starting period during which the lamp stays at a low resistance. A higher load resistance normally means better switching efficiency. The parameters of capacitor 9, inductor 10 and inductor 8 are optimized, based on the lamp characteristic resistance and the switching frequency, to make switch 5 work at zero-current switching mode under the full load condition.

The PPM pulse source 1 works as the pulse source for power switch driver 2. The PPM pulse source 1, switch driver 2, switch current amplitude feedback circuit 3 and the power switching circuit work together, functioning as a power switching source with constant power output to energize lamp 11.

The DC starter circuit includes inductor 10, SIDAC 12, capacitor 13 and resistor 14. SIDAC 12 has breakdown voltage <V+ but larger than the lamp work voltage, and is connected to inductor 10 tap, with tapping ratio >=15:1. Before lamp 11 is ignited, the voltage over capacitor 13 will eventually reach SIDAC 12 breakdown voltage. The high voltage pulse over lamp 11 triggered by SIDAC breakdown ignites lamp. After lamp 11 is ignited, the voltage over capacitor 13 is limited by the lamp work voltage and puts the DC starter circuit in standby mode. Resistor 14 that controls the charging current over capacitor 13 can be used to adjust the ignition frequency. Ideally the DC starter should have an ignition frequency of few pulses per second, for open circuit protection of the DC starter itself.

To prevent AAR, the PPM pulse source 1 works at PPM mode with a fixed frequency. The fixed pulse frequency can be from a few KHz to a few hundred KHz. the PPM can be two or more phases. To effectively prevent AAR, the test results show that the maximum phase jump distance should be <=10 pulse periods. To avoid low frequency AAR, the period of PPM sequence should be >=5 ms. For two phased modulation, a 2^{N}−1 binary pseudo-random sequence can be used with 0 and 1 representing two phases and the maximum phase jump distance <=N. For 3 or more phased modulation, the PPM sequence can have a fixed phase jump distance N with the output pulses repeated N pulse periods for each phase in the PPM sequence. The PPM method causes no acoustic noise and lower level of electromagnetic noise compared with the PFM method.

The pulse deduction method is used in the present invention to protect the ballast from overload during the lamp starting period. Whenever an overload condition is detected, the PPM pulse source 1 will suspend next pulse output to reduce power transferred to lamp 11. At the worst overload case, this method can cut power output by half. In the ballast circuit shown in FIG. 1, the overload condition can be detected by monitoring switch current width through pulse current width feedback circuit 4. At normal work condition, inductor 8 and switch 5 works at zero current switching mode. The overload will cause current resonance among inductor 8, capacitor 9 and inductor 10 through diode 7, that results in a smaller current pulse width on switch 5 because of the non zero current switching for switch 5 and inductor 8.

The open load protection is achieved by lamp 11 and switch 5 in DC series connection. Whenever lamp 11 is disconnected, the current over switch 5 will be cut to weak DC starter current.

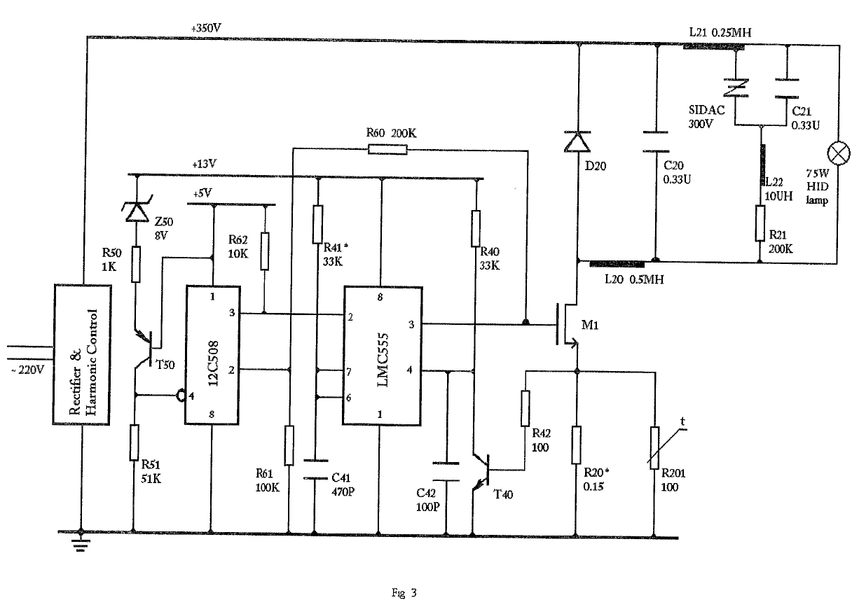

In ballast circuit shown in FIG. 1, there's a DC bias voltage over lamp 11. For large power lamp with long lamp tube, this DC bias may cause uneven lighting over the lamp tube. A lower pulse frequency can help overcome the uneven light, but will result with the larger switch current and inductor size. In ballast circuit like the one shown in FIG. 2, extra components are added to remove this DC bias after lamp is ignited. When a current over switch 5 is detected, slave switch 15 is turned on with the same on time as switch 5 after a delay of a half pulse period. Before lamp 11 is ignited, the voltage on capacitor 19 is V+because of bleeder resistor 18. The ballast circuit works the same way as FIG. 1 circuit to ignite lamp.

After lamp 11 is ignited, switch 5 and slave switch 15 work at a push and pull mode to energize lamp 11 with AC current. The weak current over bleeder resistor 18 can be ignored, and the voltage over capacitor 19 is decided by the ratio of capacitor 17 and capacitor 19.

FIG. 3 shows an electronic HID ballast implementation based on FIG. 1 circuit. Component parameters given in FIG. 3 are for 75 w HID lamp. MPU chip PIC16C508 is programmed as PPM pulse source 1. A LMC555 is used as switch driver 2. R60 and R61 are used as the switch current width feedback circuit 4. R42 and T40 are used as the switch current amplitude feedback circuit 3. Thermistor R201 with a negative temperature coefficient is used for T40 V_{be} thermal compensation. D20 is for diode 7, MOSFET M1 for switch 5, R20 and R201 for resistor 6, L20 for inductor 8, L21 for inductor 10, C20 for capacitor 9, C21 for capacitor 13 and R21 for resistor 14. A small inductor L22 is added into the DC starter circuit to boost the ignition pulse voltage.

R40, R41, C40, C41 and LMC555 form a standard 555 monostable circuit that outputs a positive pulse at LMC555 pin 3 for each negative input pulse at LMC555 pin 2. The output pulse width can be adjust by R40 and is set to 12 us at open load mode. LMC555 is also a pulse voltage converter that takes 5 v MPU pulse input and outputs 13 v pulse to drive M1.

Z50, R50, T50 and R51 combined are used as a under voltage protection circuit for +13V power source to prevent MOSFET from overheat damage caused by unsaturated conduction. Whenever +13V power source voltage dropped below 12V, the corresponding voltage drop on R51 will reset MPU to stop pulse output.

The MPU output pulses on PIC16C508 pin 3 has a fixed period of 58 us with 3 phases PPM, and the output pulse is an 1 us negative pulse. Three phases are −2 us, 0 us and 2 us. The fixed phase jump distance is 7. Output pulses repeat 7 pulse periods at each phase and then jump to a new phase. The PPM sequence has a period of approximately 10 ms.

At normal work condition, the M1 current width is approximately 8 us. The output pulse deduction is triggered whenever the M1 current width is less than 6 us.

We claim:

1. A method to prevent acoustic arc resonance (AAR) in a high frequency electronic ballast for a High-Intensity-Discharge (HID) lamp, comprising of:
The pulse source of the high frequency electronic ballast working at the Pulse-Phase-Modulation (PPM) mode with a fixed frequency to prevent AAR;

2. The method to prevent AAR in the high frequency electronic ballast as claimed in claim 1, wherein the PPM of the pulse source can be two or more phased modulation and the fixed frequency of the pulse source can be from a few KHz to a few hundred KHz;

3. The method to prevent AAR in the high frequency electronic ballast as claimed in claim 1, wherein the PPM of the pulse source has maximum phase jump distance <=10 pulse periods;

4. The method to prevent AAR in the high frequency electronic ballast as claimed in claims 1 and 2, wherein the pulse source has the PPM sequence period >=5 ms for preventing low frequency AAR;

5. The method to prevent AAR in a high frequency electronic ballast as claimed in claims 1 and 2, wherein the two phased modulation of the pulse source can be a 2^{N}−1 pseudo-random sequence, with 0 and 1 representing two phases and the maximum phase jump distance N<=10;

6. The method to prevent AAR in a high frequency electronic ballast as claimed in claims 1 and 2, wherein the 3 or more phased modulation of the pulse source can use the fixed maximum phase jump distance N, with the output pulses repeating N pulse periods for each phase in the PPM sequence;

7. An electronic HID ballast, comprising:
A power switching circuit for energizing the HID lamp;
A switch driver for driving the power switching circuit;
A coupling circuit for improving power coupling between the power switch circuit and the HID lamp;
A PPM pulse source with the PPM and a fixed frequency as the method claimed in claim 1, for driving the power switching circuit through the switch driver;
A DC starter for igniting the HID lamp with adjustable low ignition frequency;
A switch current amplitude feedback circuit for detecting the power switching current pulse amplitude and sending the signal to the switch driver; and
A switch current width feedback circuit for detecting the power switching current pulse width and sending the signal to the PPM pulse source;

8. The electronic HID ballast as claimed in claim 7, wherein the power switching circuit comprises a switch, an inductor, a diode and a sampling resistor, and is driven by the PPM pulse source through the switch driver, and to energize the lamp through the coupling circuit;

9. The electronic HID ballast as claimed in claim 7, wherein the coupling circuit comprises an inductor, a capacitor and the lamp connected in a parallel LRC loop, and is used to boost the lamp's equivalent load resistance in the power switching circuit, thus to improve the power coupling efficiency;

10. The electronic HID ballast as claimed in claim 7, wherein the PPM pulse source, the switch driver, the switch current amplitude feedback circuit and the power switching circuit work together, functioning as a power switching source with constant power output to energize the lamp;

11. The electronic HID ballast as claimed in claim 7, wherein the DC starter comprises a SIDAC, a capacitor, a resistor and the inductor in the coupling circuit, with SIDAC connected to the inductor tap with tapping ratio >=15:1, and has an adjustable ignition frequency controlled by the resistor;

12. The electronic HID ballast as claimed in claim 7, wherein the pulse deduction method is used for the ballast overload protection by the pulse source suspending the next pulse output whenever the overload condition is detected;

13. The electronic HID ballast as claimed in claims 7 and 8, wherein the overload condition can be detected by the switch current width feedback circuit monitoring current pulse width of the switch in the power switching circuit;

14. The electronic HID ballast as claimed in claims 7 and 8, wherein the open load protection is achieved by making the lamp and the power switching circuit in series connection;

15. The electronic HID ballast as claimed in claims 7 and 8, wherein the switch in the power switching circuit can be a MOSFET, an IGBT, or a bipolar power transistor when a proper switch driver is applied;

16. The electronic HID ballast as claimed in claim 7, 8 and 11, wherein the DC bias over the lamp can be removed, by comprising:
A slave switch to work with the switch in the power switching circuit at the push and pull mode after the lamp is ignited;
Two capacitors to work as the voltage divider after the lamp is ignited; and
A bleeder resistor for the DC starter working the same way as in claim 7;

17. The electronic HID ballast as claimed in claims 7 and 8, wherein an implementation can applied, by comprising:
A MPU programmed as the PPM pulse source;
A MOSFET as the switch in the power switching circuit;
A LMC555 as the switch driver;
A transistor and a resistor as the switch current amplitude feedback circuit;
Two resistors as the switch current width feedback circuit; and
An under voltage protection circuit for preventing MOSFET from overheat damage caused by unsaturated conduction;

18. The electronic HID ballast as claimed in claim 17, wherein the under voltage protection circuit comprises a zener diode, a PNP transistor and two resistors.
